(19) United States
(12) Patent Application Publication
(10) Pub. No.: US 2014/0164278 A1
(43) Pub. Date: Jun. 12, 2014

(54) DELIVERY MANAGEMENT AND ORDER SYSTEM

(71) Applicants: Ben Cattoor, Maplewood, MN (US); Parag Shah, Roseville, MN (US)

(72) Inventors: Ben Cattoor, Maplewood, MN (US); Parag Shah, Roseville, MN (US)

(21) Appl. No.: 13/935,257

(22) Filed: Jul. 3, 2013

Related U.S. Application Data
(60) Provisional application No. 61/667,611, filed on Jul. 3, 2012.

(51) Int. Cl. G06Q 10/08

(52) U.S. Cl. CPC G06Q 10/083
USPC 705/330

(57) ABSTRACT

A delivery management system and method enables an individual to create a delivery location and order a product offering from a delivery service provider, and enables the delivery service provider to create a unique delivery schedule by choosing at least one delivery day and time that it will deliver to at least one location, using an interactive communication network.

### CROSS-REFERENCE TO RELATED APPLICATION

This application claims the benefit of U.S. Provisional Application No. 61/667,611, filed Jul. 3, 2012, titled DELIVERY MANAGEMENT AND ORDER SYSTEM.

### TECHNICAL FIELD

The present disclosure relates to a delivery management system and use of the system through an interactive communication network to meet delivery management needs. More specifically, the methods described herein relate to a system that creates opportunities for businesses in the areas of delivery service and delivery management through the use of e-commerce.

### BACKGROUND

Currently, options for delivery, especially in suburban areas, are limited due to the existing structure of the delivery system. The existing delivery system begins with a customer, usually an individual, contacting a delivery service provider (for example, by phone, fax or internet) to place an order for immediate delivery to the customer's chosen, specific location, such as a house, apartment, dorm, office, school building, gym, or library, among others. The delivery service provider accepts the order, puts together the order, and delivers the order to the customer's specified location. Each delivery service provider delivers orders based on the time they are placed, and those providers deliver one order at a time to almost any location the customer specifies.

One reason why delivery options for individuals are limited is because many service providers choose not to enter the delivery market due to the high cost associated with the existing delivery system. This is especially true for restaurants in non-urban areas. In order to maintain the process of delivering goods to a wide delivery area at the time and place of the individual's choice, a delivery service provider will have large overhead costs. Therefore, in the food industry, few restaurants choose to deliver and, consequently, individuals' delivery options for lunch and dinner are limited compared to the number of available restaurants in the area.

If a service provider does choose to enter the delivery market, that service provider must hire additional staff or services to fulfill the processes involved in delivery such as filling the order and delivering it to a specified location. Additionally, service providers run the risk of receiving too many orders at one time. This can overload the process of putting orders together. In the food industry, this peak order time often exists, and adding a delivery service may dramatically increase the number of food orders at that time. If orders increase too dramatically at one peak time, the restaurant may not be able to manage all of the orders. This could lead to decreased quality and consistency for customers.

In view of the high overhead costs for delivery service providers, limited delivery options for individuals, and existing complications surrounding peak order times, a need exists for a more efficient delivery method. There also exists a need for managing delivery methods by tracking delivery data and determining information such as ideal delivery locations, days, times, and order sizes.

### SUMMARY

In general terms, the present disclosure relates to a system and related methods that overcome existing issues in inefficient delivery methods as well as issues related to the management of delivery services. Although the invention is described in connection with providing food services via restaurants, the system and method disclosed herein can also be applied to service providers other than restaurants, including florists, gift shops, grocery providers, beverage services and the like.

One aspect is a method that enables an individual to create and add an unavailable delivery location to a delivery management system through an interactive communication network; enables other individuals located at the previously unavailable delivery location to register for said delivery location; and enables a third party or the delivery management system to permit said delivery location to become an available delivery location.

One aspect is a method that provides individuals and delivery service providers with access to a delivery management system through an interactive communication network, wherein the delivery management system enables delivery service providers to choose at least one day and time over a given time period to offer delivery of their product offerings; enables an individual to choose an available delivery location; enables the individual to choose a day and time for delivery; enables the individual to choose an available delivery option; enables the individual to choose product offerings from the delivery service provider's menu; enables the individual to pay for the chosen product offerings; enables the delivery service provider to receive the individual's chosen product offerings; and enables the delivery service provider to deliver the individual's chosen product offerings on the chosen day at the chosen time.

Additionally, the delivery management system or a third party may collect data on the use and outcomes of the disclosed system and methods. If the data is collected, the delivery management system or the third party can analyze the collected data for the purpose of sharing the raw or analyzed data with current or potential delivery service providers.

### BRIEF DESCRIPTION OF THE DRAWINGS

FIG. 1 represents an example method used by an individual to order product offerings when the individual is ordering from an available delivery location.

FIG. 2 represents a method to create and add a new available delivery location.

FIG. 3 is a flow chart representing an example method used by a delivery service provider as described herein.

FIG. 4 is a flow chart representing the current delivery method.

FIG. 5 is a flow chart representing the components of one embodiment of the system described herein.

FIG. 6 is a schematic block diagram of an example computing system that may be used in accordance with one embodiment of the present invention.

### DETAILED DESCRIPTION

Various embodiments will be described in detail with reference to the drawings. Reference to various embodiments does not limit the scope of the claims attached hereto. Additionally, any examples set forth in this specification are not intended to be limiting and merely set forth some of the many possible embodiments for the appended claims.

In general terms, the system and methods described herein enable an individual to create a delivery location and order a product offering from a delivery service provider, and enable the delivery service provider to create a unique delivery schedule by choosing at least one delivery day and time that it will deliver to at least one location.

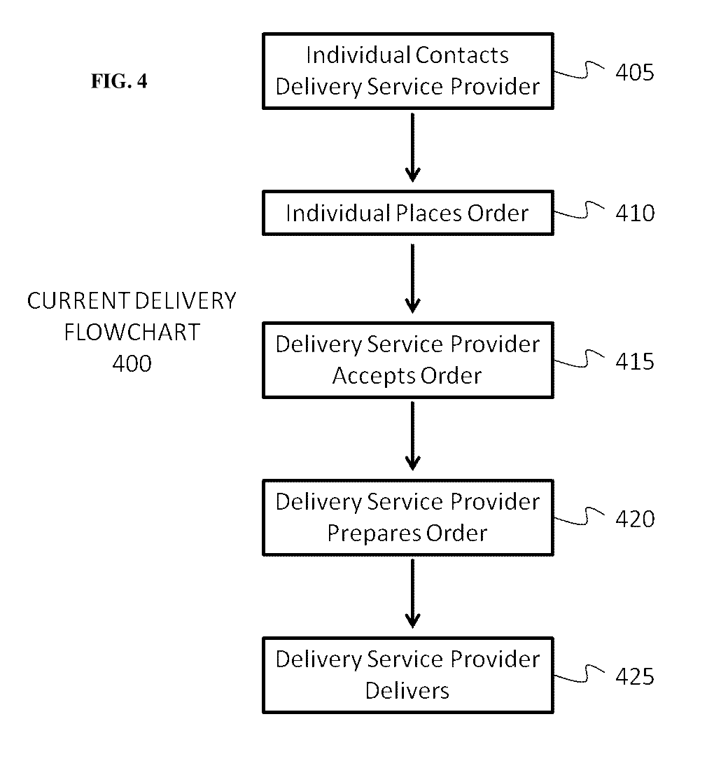

Referring to FIG. 4, the system and methods described herein improve upon the existing delivery system (400). The existing delivery system (400) begins with a customer, usually an individual, contacting a delivery service provider (405) by phone or internet to place an order (410) for immediate delivery to the customer's chosen, specific location, such as a house, apartment, dorm, office, school building, gym, or library. The delivery service provider accepts the order (415), puts together the order (420), and delivers the order (425) to the customer's specified location. Typically, each delivery service provider delivers orders based on the time they are placed, and those providers deliver one order at a time to almost any location the customer specifies.

The term “delivery management system” refers to a software application that can be accessed on a personal computer, mobile phone, tablet, or other networked device. As one example, the delivery management system could be a web application that is accessed on a PC and viewed in a browser window. As another example, the delivery management system could be a mobile application connected to a remote data network.

The term “interactive communication network” refers to a data network that, among others things, allows an individual or entity to share information with other individuals or entities that have access to the data network. Multiple parties can exchange information with each other.

The term “available delivery location” refers to a location that can be delivered to using the methods described herein. It may be where an individual is located or is near to when that individual is placing an order for delivery. An available delivery location is a location that has been added to the delivery management system, as illustrated by the methods described herein, and it is a location that at least one delivery service provider is willing to deliver to. The available delivery location is where the ordered product offerings will be delivered to by the delivery service provider and where the individual can access and obtain his or her ordered product offerings.

The term “delivery service provider” may refer to a business that sells products and is capable of delivering those products to consumers at locations such as, but not limited to, office buildings, apartment buildings, or schools. An available delivery service provider is a delivery service provider that has registered with the delivery management system by providing its information and that is willing to deliver to at least one available delivery locations located within its parameter as described by the methods herein. If the delivery service provider is not willing to deliver to some locations, the delivery service provider will not be an available delivery service provider for those locations. Additionally, if the delivery service provider is not willing to deliver during a predetermined period of time, for example, a particular day of the week, that an individual has chosen, it will not be an available delivery service provider for that period of time. The delivery service provider may decide how the orders will be delivered to the individual(s). For example, the deliveries may be completed by the delivery service provider or by a person, business, or service, such as a courier, that it has hired to complete deliveries.

The term “product offerings” may refer to the products that a delivery service provider is capable of delivering. They may include products such as, but not limited to, food, flowers, gifts, groceries, or beverages.

The first exemplary embodiment of a method described herein enables an individual to create and add an unavailable delivery location to a delivery management system through an interactive communication network; enables other individuals located at the previously unavailable delivery location to register for said delivery location; and enables a third party or the delivery management system to permit said delivery location to become an available delivery location. The term “individual” as used herein may refer to a customer.

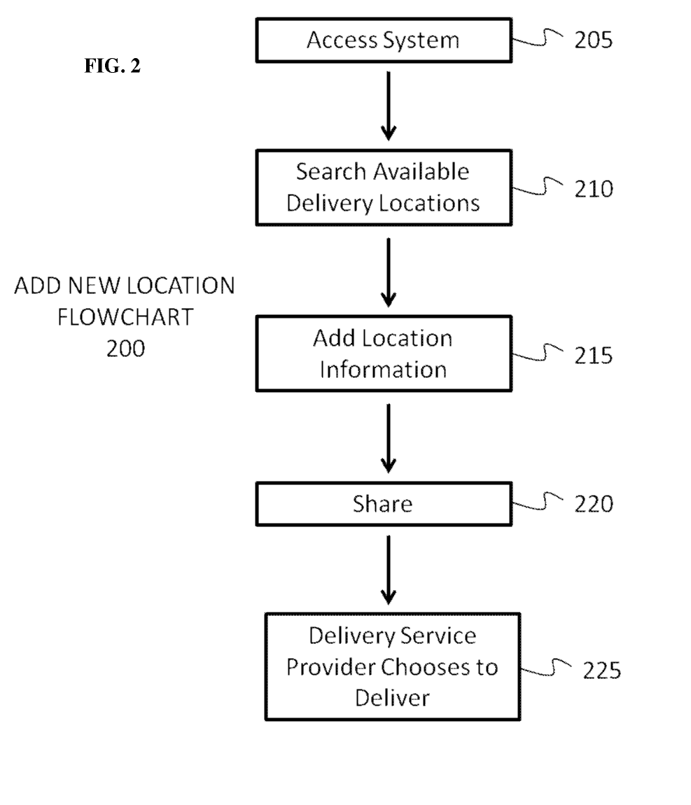

FIG. 2 is a flow chart illustrating the method of adding a new location (200) according to one embodiment of the present invention.

In the embodiment illustrated in FIG. 2, an individual joins the interactive communication network via personal computer, mobile phone, tablet, or other web-enabled device and accesses a delivery management system (205) through the use of, for example, a website or mobile application.

Once the individual has accessed the delivery management system (205), the individual can register and create a user name, password, and consumer profile. After the individual registers with the delivery management system, the individual is able to place orders with the delivery management system. The profile can include, but is not limited to, the individual's location, favorite food type, favorite restaurants, specific health diets, and saved credit card information. If the individual is already registered, the individual can sign in to the delivery management system with a user name and password.

Based on the individual's consumer profile, the delivery management system may be able to automatically make product offering suggestions to the individual. Suggestions may also be based on current service providers' product offerings available on the delivery management system that day.

To initiate the process of ordering product offerings for delivery, the individual may search for an available delivery location (210). If the individual's delivery location is an unavailable delivery location, the individual can register the delivery location with the delivery management system. The individual can register by including location information (215) such as, but not limited to, the name of the new delivery location, the address of the new delivery location, the number of other individuals located at the new delivery location, and the time or time range during which the individuals would like to receive orders.

After an individual has registered a delivery location, the individual can share the location (220), allowing other individuals at that location to register and create a user name, password, and consumer profile. In one embodiment, the individual can enable automatic sharing to other persons in the individual's social network, especially to those in immediate proximity to the individual, such as co-workers.

After enough individuals have registered at one location, a third party or the delivery service provider may permit the new delivery location to become an available delivery location (225). The number of individuals required by the third party or delivery service provider may be a predetermined number; for example, a third party or delivery service provider may require at least five individuals to register at one location before the location is permitted to become an available delivery location. The delivery service provider could permit automated approval of a new delivery location after such location attains a pre-determined numerical registration threshold.

Additionally, the third party may collect all information made available by the individuals and make the information available on the delivery management system to delivery service providers.

Another exemplary embodiment of a method described herein provides individuals and delivery service providers with access to a delivery management system through an interactive communication network, wherein the delivery management system enables delivery service providers to choose at least one day and time over a given time period to deliver product offerings; enables an individual to choose an available delivery location; enables the individual to choose a day for delivery; enables the individual to choose an available delivery option; enables the individual to choose product offerings from the delivery service provider's menu; enables the individual to pay for the chosen product offerings; enables the delivery service provider to receive the individual's chosen product offerings; and enables the delivery service provider to deliver the individual's chosen product offerings on the chosen day at the chosen time.

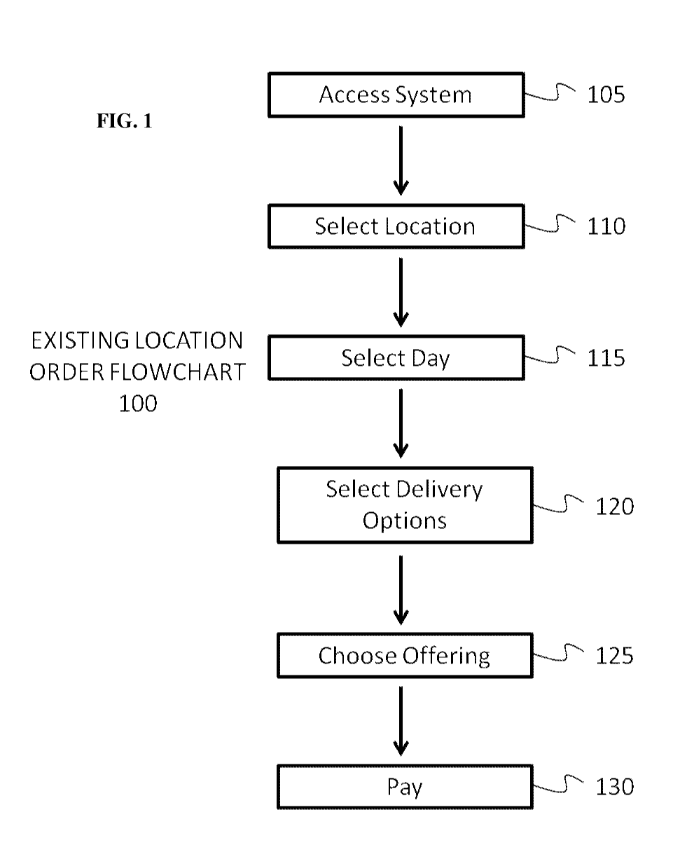

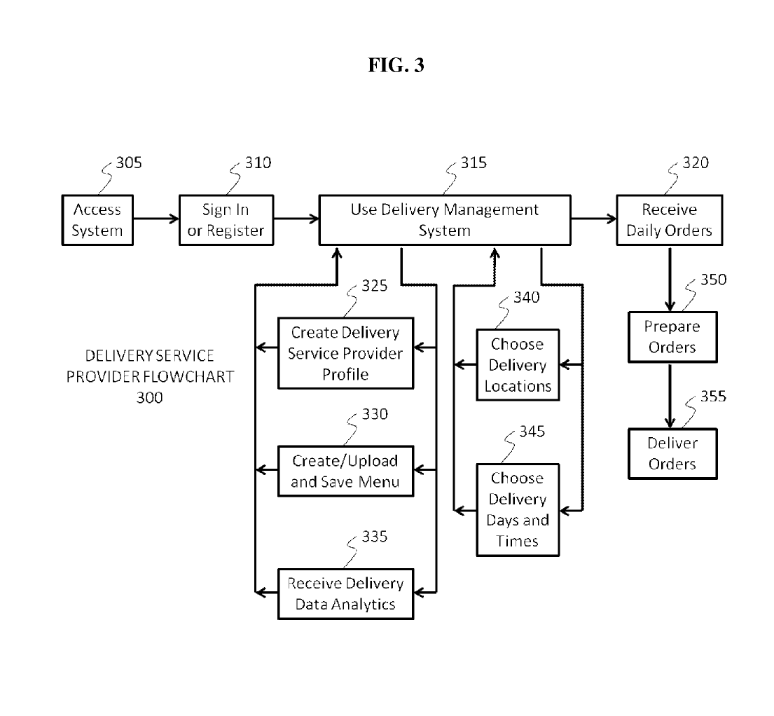

Referring to FIG. 1 and FIG. 3, an example of a particular embodiment of the methods described herein is provided to illustrate the methods described herein.

FIG. 3 illustrates one example of use of the system by a delivery service provider (300). A delivery service provider joins an interactive communication network via personal computer, mobile phone, tablet, or other web-enabled device and accesses a delivery management system (305) through the use of, for example, a website or mobile application.

Once the delivery service provider has accessed the delivery management system (305), the delivery service provider can register (310) by providing the delivery management system or a third party with information such as, but not limited to, a user name, a password, the delivery service provider's name, contact information, type of service, address, and other identifying information. After the delivery service provider registers (310) with the delivery management system, the delivery service provider is able to use the delivery management system (315).

If the delivery service provider has already registered, the delivery service provider can sign in (310) to the delivery management system with its selected user name and password.

The delivery service provider can also create a profile (325) on the delivery management system that may be viewable by individuals using the interactive communication network. The profile may include information such as, but not limited to, the type of product offerings the service provider sells. For example, if the delivery service provider is a restaurant, the information about product offerings may distinguish the type of food being delivered, such as, but not limited to, Chinese food, Italian food, Deli food, American food, Greek food, or Southwestern food.

Within the delivery management system, the delivery service provider can create a menu or upload a pre-existing menu (330). The delivery service provider can also save one or more menus to the delivery management system. The menu can have a list of product offerings, and the delivery service provider can change or customize the menu at any time. Additionally, the delivery service provider can display different menus to individuals at different locations.

In some embodiments, each menu may have named items, wherein each named item may also have a description, price, or corresponding image. Individuals may see one menu for each delivery service provider.

The delivery service provider can also determine its delivery schedule using the delivery management system (315). It can choose delivery locations (340) by indicating on the delivery management system specific geographical areas to which it is willing to deliver. The third party can set a default parameter based on a distance from the delivery service provider's location. The delivery service provider may increase or decrease the parameter if it desires.

Based on the default or changed parameter, the third party can use a list or map to indicate available delivery locations for the delivery service provider. The available delivery locations can have a specified name and address associated with them. Additional notes can be added to each delivery location such as, but not limited to, drop-off details.

The delivery service provider can select which available delivery locations (340) within its parameter it is willing to deliver to. It can also create one or more available delivery days and delivery times (345), for individuals at each available delivery location it has chosen to deliver to. It can then make its menu available to individuals registered at each location that it is willing to deliver to.

Once the delivery service provider has indicated its parameter, the third party may use the parameter to alert the delivery service provider of newly available delivery locations (340) that become available after the delivery service provider has registered for the delivery management system (310). If the delivery service provider chooses to deliver to a new location, it can make a menu available to (330), and create one or more delivery days and times (345) for, individuals at the newly available delivery location.

When the delivery service provider has indicated which day or days of the week it is willing to deliver on and which time or times on those days it is willing to deliver at (345), it can also input the time needed to prepare the product offerings so that the delivery management system or the third party can determine, and share with individuals, the cut-off time by which individuals must place their orders. Based on the selected cut-off time, the delivery management system or the third party will not allow any orders to be made by individuals after the cut-off time has passed.

The delivery service provider can also indicate a maximum order size per delivery. One delivery may be to one location or to a group of two or more locations. The maximum order size per delivery may be customized based on delivery locations, days, or times. If the maximum order size has been attained for one delivery, the delivery management system will no longer allow individuals to make orders for locations that are part of that delivery, on that day, at that time.

In addition to the above choices, the delivery service provider can also input preferences on the delivery management system such as, but not limited to, preferred building size to deliver to, one delivery to multiple locations versus one delivery to one location, days of the week it would prefer to deliver on, available delivery locations it would like to deliver to, and other information a third party can use to direct the delivery service provider to choose optimal delivery options. The choices may be based on historical average order for certain building sizes, available delivery locations, or other grouping methods.

The third party, or the delivery management system, can collect data from all deliveries made by all delivery service providers. The data collected can include information such as, but not limited to, available delivery locations that delivery service providers delivered to; the number of registered individuals at each available delivery location; the types of product offerings available to individuals; the number of orders placed on particular days or at particular times, or both; the amount of product offerings individuals order at one time; or the prices paid by individuals per order.

The third party, or the delivery management system, can make all collected data available to delivery service providers (335). Additionally, the third party can manually analyze the data to determine generic or specific business strategies such as, but not limited to, optimal delivery schedules, optimal delivery locations, or optimal delivery sizes. The third party may share the analyzed data with one or more delivery service providers (335). The delivery service providers can use this data to evaluate and determine their delivery preferences such as, but not limited to, preferred delivery days, preferred delivery times), preferred cut-off order times, preferred delivery locations, or preferred maximum delivery sizes.

Alternatively, the delivery management system may automatically analyze the data to determine generic or specific business strategies such as, but not limited to, optimal delivery schedules, optimal delivery locations, or optimal delivery sizes. The delivery management system may share the analyzed data with one or more delivery service providers (335). The delivery service providers can use this data to evaluate and determine their delivery preferences such as, but not limited to, preferred delivery days, preferred delivery times, preferred cut-off order times, preferred delivery locations, or preferred maximum delivery sizes.

Once the delivery service provider has established at least one delivery day (345), at least one delivery time (345), at least one delivery location (340), and at least one menu (330), individuals can place orders on the delivery management system. The delivery service provider can also establish maximum delivery sizes and cut-off order times prior to allowing individuals to place orders on the delivery management system.

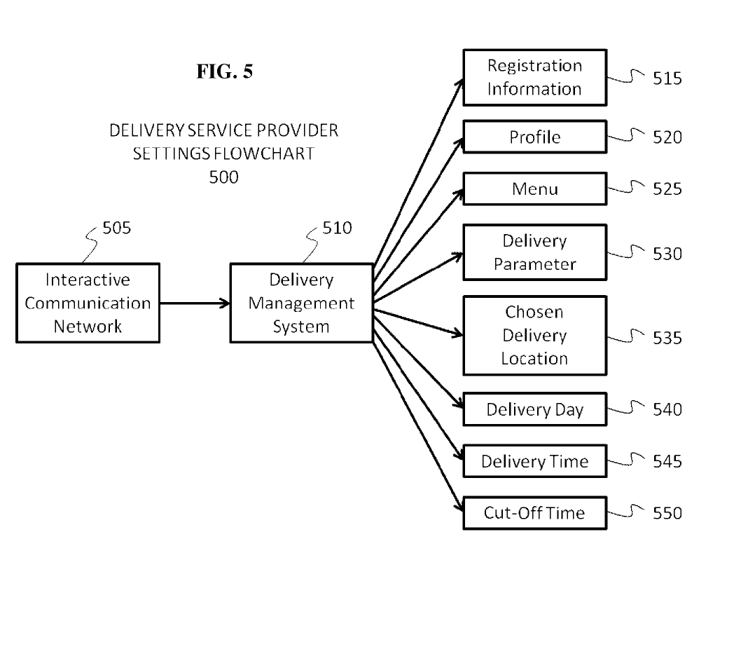

Referring to FIG. 5, the system may include various delivery service provider settings (500). The delivery service provider accesses the delivery management system (510) via an interactive communication network (505). The delivery management system (510) may contain delivery service provider information such as registration information (515), profile (520), menu (525), delivery parameters (530), chosen delivery location (535), delivery day (540), delivery time (545), and cut-off time (550), among others.

Referring now to FIG. 1, an individual joins the interactive communication network via personal computer, mobile phone, tablet, or other web-enabled device and accesses the delivery management system (105) through the use of, for example, a website or mobile application.

Once the individual has accessed the delivery management system (105), the individual can register and create a user name, password, and consumer profile. After the individual registers with the delivery management system, the individual is able to place orders with the delivery management system as illustrated in FIG. 1. If the methods described herein are being used in the food industry, the profile can include, but is not limited to, the individual's location, favorite food type, favorite restaurants, specific health diets, and saved credit card information. If the individual is already registered, the individual can sign in to the delivery management system with a user name and password.

Based on the individual's consumer profile, the delivery management system may be able to automatically make product offering suggestions to the individual. Suggestions may also be based on current delivery service providers' product offerings available on the delivery management system that day.

To initiate the process of ordering product offerings for delivery (100), the individual may select an available delivery location (110). If the individual's location is not an available delivery location, the individual can register the delivery location as previously described in reference to FIG. 2.

Once the individual has selected an available delivery location (110), the individual may then select a day (115) that the individual would like product offerings delivered to the individual's available delivery location.

The delivery management system may then display available delivery options for the individual such as, but not limited to, available delivery service providers and available times during which delivery service providers are willing to deliver to the available delivery location on the selected day. The individual can select the delivery options (120). For example, the individual can select the delivery service provider that the individual wishes to order product offerings from. If the delivery service provider is delivering to the individual's available delivery location more than one time on the selected day, the individual will have to choose the time at which the individual would like the product offerings delivered to the available delivery location. Alternatively, the delivery options may be displayed together so that the individual can select an available delivery service provider and available delivery time simultaneously. The individual may also be able to see all locations that a delivery service provider is willing to deliver to even if the delivery service provider is not willing to deliver to the individual's available delivery location.

Additionally, the individual may be notified each day, prior to accessing the delivery management system, of what delivery service providers are delivering to the individual's available delivery location on that day. Notifications may be by electronic means such as, but not limited to, email, text message, or mobile application notifications.

The delivery service providers may have one or more pre-selected delivery times available for the day the individual selected. Based on the pre-selected delivery time, a cut-off order time will be associated with that day's delivery. The individual will need to place an order prior to the designated cut-off order time.

If the individual is interested in ordering from a service provider that is not an available delivery service provider, the individual can contact the third party requesting the addition of the service provider. The individual can include information such as, but not limited to, the name of the desired service provider, the street address of the available delivery location, and the frequency with which the individual will order from the service provider. The third party may then solicit the service provider in person, over the phone, or through e-mail, and request that it register with the delivery management system.

Alternatively, the individual may select delivery options (120), such as a delivery service provider prior to selecting a delivery date (115). If the individual chooses the delivery options (120) first, the delivery management system will indicate which days the delivery service provider is willing to deliver product offerings to the individual's delivery location. The individual can then select the desired delivery day (115). The delivery management system will also notify the individual of any cut-off order times and any delivery times for the selected delivery service provider on the selected delivery day. If the delivery service provider is delivering to the individual's available delivery location more than one time on the selected day, the individual will have to choose the time at which they would like the product offerings delivered to the available delivery location.

The individual may then select one or more product offerings (125) from the delivery service provider's menu of product offerings for the individual's available delivery location. Alternatively, the delivery management system can automatically provide the individual with recommended product offerings from the delivery service provider's menu after the individual selects a delivery location, day, and time. The recommendations can be based on information the individual has included in a profile or they can be provided randomly.

Once the individual has selected the desired product offerings (125), the individual can pay (130) for the product offerings. Payment may be made to the third party in one of many forms including, but not limited to, a credit card, coupon, electronic payment, or charge to an account. Once the third party has received payment, it can confirm the order with the individual by e-mail, text message, calendar invite, fax, or other method. The confirmation can act as a reminder to the individual about the order details such as day, time, delivery location, delivery service provider, and ordered product offerings. Many other individuals within the same available delivery location can also place, and pay for, orders using this method.

The third party may transfer the payment to the delivery service provider that the individuals ordered from by providing the delivery service provider with a check, cash, money transfer, or other form of payment. Alternatively, the third party may retain a portion of the payment before transferring the remainder of the payment to the delivery service provider. Payment from the third party to the delivery service provider may be on a set schedule.

The individual may be able to save any orders within the delivery management system so that, in the future, the individual can select a previously saved order and place the same order again. The delivery management system can automatically provide the individual with previously saved orders if the individual selects a delivery service provider and that individual has saved orders from the delivery service provider.

The third party may collect the orders from all individuals who place orders on the delivery management system via an interactive communication network. The orders may include information such as, but not limited to, the selected product offering or offerings, the prices of any selected product offerings, the delivery location of the individual who placed the order, the delivery day the individual chose, and the delivery time the individual chose. The third party can then share the orders with the applicable delivery service providers through the use of a personal computer, mobile device, fax machine, or other web-enabled device.

The delivery service provider can view orders grouped together based on location, day, and/or time of delivery. The delivery service provider can then prepare the orders and deliver the prepared orders based on the information provided by the individuals such as the individuals' location, the day, and the time.

When the selected product offerings have been delivered, the delivery service provider or the third party can notify the individual by means such as, but not limited to, email, text message, mobile application notification, or phone. Alternatively, the notification may be automatically sent to the individual when the scheduled delivery time has been reached. The delivery service provider or the third party can also notify the individual by similar means if the order will be delivered late.

The presently described system provides numerous advantages, including an overall increased efficiency for the delivery service provider. The invention allows delivery service providers, including those who already deliver, to benefit from significant energy savings by reducing the number of deliveries made per location, per day. Instead of getting multiple orders for delivery all to the same location at different times determined by individuals, the present invention allows a service provider to pick one delivery time per day to deliver multiple orders.

Additionally, due to minimizing the number of deliveries made as well as being able to control the overall distance to delivery location where each delivery is made, service providers are able to manage related transportation liability risk. Further, the present invention gives the service provider the ability to significantly maximize overall efficiency of their employees. The invention allows the service provider to more appropriately plan for increased volume based on historical orders generated per delivery location and day, and also minimizes the risk of being overburdened on any given day due to the ability to set a maximum number of orders. This allows for the service provider to maximize employee efficiency.

Another unique advantage available through the system is the ability to designate a hyper-local and centralized consumer prepared food delivery location within a specific building. This in-building location can be optimized for various usability factors, such as traffic patterns, space convenience, temperature or other climate conditions, or security. With increased food safety and security regulation, the ability to designate and control a precise in-building location could be critical. This could involve the use of an access-restricted kiosk. The kiosk could include password protection, temperature regulation or other features that permit safe and convenient food management for the individuals and delivery service providers. As an additional benefit, the kiosk could include user-controlled compartments, divided either by individual or by delivery service provider. The kiosk could include regions for hot and cold storage or for different types of food. The former could provide food safety and quality benefits and the latter could provide food sensitivity management. A delivery service provider could isolate wheat or peanut foods from other types.

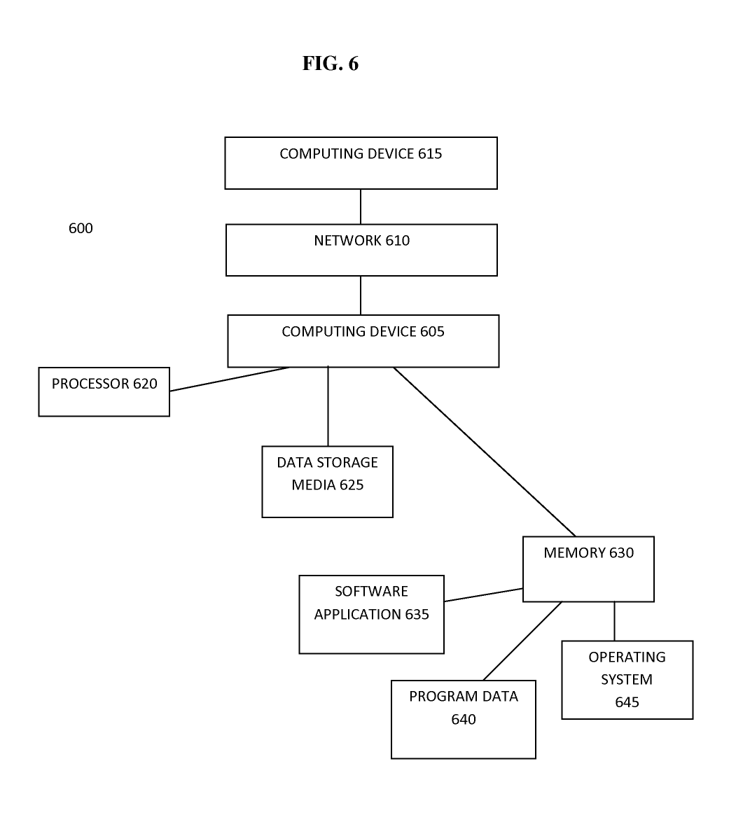

The disclosed invention involves technology that uses a computing system. FIG. 6 is a schematic block diagram of an example computing system 600. The invention includes at least one computing device 605. In some embodiments the computing system further includes a communication network 610 and one or more additional computing devices 615 (such as a server).

Computing device 605 can be, for example, located in a place of business or can be a computing device located in a user's home or office. In some embodiments, computing device 605 is a mobile device. Computing device 605 can be a stand-alone computing device or a networked computing device that communicates with one or more other computing devices 615 across a network 610. The additional computing device(s) 615 can be, for example, located remotely from the first computing device 605, but configured for data communication with the first computing device 605 across a network 610.

In some examples, the computing devices 605 and 615 include at least one processor or processing unit 620 and system memory 630. The processor 620 is a device configured to process a set of instructions. In some embodiments, system memory 630 may be a component of processor 620; in other embodiments system memory is separate from the processor. Depending on the exact configuration and type of computing device, the system memory 630 may be volatile (such as RAM), non-volatile (such as ROM, flash memory, etc.) or some combination of the two. System memory 630 typically includes an operating system 645 suitable for controlling the operation of the computing device, such as the Linux operating system. The system memory 630 may also include one or more software applications 635 and may include program data 640.

The computing device may have additional features or functionality. For example, the device may also include additional data storage devices 625 (removable and/or non-removable) such as, for example, magnetic disks, optical disks, or tape. Computer storage media 625 may include volatile and nonvolatile, removable and non-removable media implemented in any method or technology for storage of information, such as computer readable instructions, data structures, program modules, or other data. System memory, removable storage, and non-removable storage are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device. An example of computer storage media is non-transitory media.

In some examples, one or more of the computing devices 605, 615 can be located in an individual's home or place of business, or in a delivery service provider or third party's place of business. In other examples, the computing device can be a personal computing device that is networked to allow the user to access the disclosed system at a remote location, such as in a user's home, office or other location. In some embodiments, the computing device 605 is a smart phone, tablet, laptop computer, personal digital assistant, or other mobile computing device. In some embodiments the invention is stored as data instructions for a smart phone application. A network 610 facilitates communication between the computing device 605 and one or more servers, such as an additional computing device 615, that host the system. The network 610 may be a wide variety of different types of electronic communication networks. For example, the network may be a wide-area network, such as the Internet, a local-area network, a metropolitan-area network, or another type of electronic communication network. The network may include wired and/or wireless data links. A variety of communications protocols may be used in the network including, but not limited to, Wi-Fi, Ethernet, Transport Control Protocol (TCP), Internet Protocol (IP), Hypertext Transfer Protocol (HTTP), SOAP, remote procedure call protocols, and/or other types of communications protocols.

In some examples, the additional computing device 615 is a Web server. In this example, the first computing device 605 includes a Web browser that communicates with the Web server to request and retrieve data. The data is then displayed to the user, such as by using a Web browser software application. In some embodiments, the various operations, methods, and rules disclosed herein are implemented by instructions stored in memory. When the instructions are executed by the processor of one or more of the computing devices 605 and 615, the instructions cause the processor to perform one or more of the operations or methods disclosed herein. Examples of operations include creating a consumer profile; searching or selecting available delivery locations; selecting product offerings for delivery; receiving daily orders; and other operations.

While the foregoing disclosure has been described in some detail for purposes of clarity and understanding, it will be appreciated by one skilled in the art from a reading of this disclosure that various changes in form and detail can be made without departing from the true scope of the disclosure and appended claims.

What is claimed is:

1. A method of operating a computer based delivery management system comprising the steps of:
causing at least one processor to execute a plurality of instructions stored in at least one memory device to operate with at least one input device to enable a user to input a delivery location to a delivery management system through an interactive communication network;
causing the at least one memory device to save the delivery location;
causing the at least one processor to execute a plurality of instructions stored in the at least one memory device to operate with at least one input device to enable at least one additional user to input data to become associated with the delivery location; and
causing the at least one processor to execute a plurality of instructions stored in the at least one memory device to enable a third party or the delivery management system to identify the delivery location as an active delivery location.

2. A method of operating a computer-based delivery management system comprising the steps of:
causing at least one processor to execute a plurality of instructions stored in at least one memory device to operate with at least one input device to provide users and delivery service providers with access to a delivery management system through an interactive communication network, wherein the delivery management system:
enables delivery service providers to choose at least one day and time over a given time period to deliver product offerings;
enables a user to choose an available delivery location;
enables the user to choose a day for delivery;
enables the user to choose an available delivery option;
enables the user to choose product offerings from the chosen delivery service provider;
enables the user to pay for the chosen product offerings;
enables the delivery service provider to receive the user's chosen product offerings; and
enables the delivery service provider to deliver the user's chosen product offerings on the chosen day at the chosen time.

3. The method of claim 2, further comprising the step of enabling the delivery service provider to add a menu with menu options to the delivery management system.

4. The method of claim 2, wherein a third party processes users' payments.

5. The method of claim 4, wherein the third party keeps a portion of users' payments.

6. The method of claim 5, wherein the third party passes the remainder of the users' payments to the delivery service provider.

7. The method of claim 2, further comprising the step of enabling many users' chosen menu options from the chosen day at the chosen time to be combined if those users have the same available delivery location.

8. The method of claim 8, wherein only one delivery is made by the delivery service provider to the available delivery location.

9. The method of claim 2, further comprising the step of enabling many users from more than one available delivery location to order from the delivery service provider.

10. The method of claim 9, wherein the delivery service provider makes one delivery per available delivery location for all of the orders placed by users at that location.

11. The method of claim 9, wherein the delivery service provider makes all deliveries concurrently as one grouped delivery.

12. The method of claim 2, further comprising the step of enabling users to be notified daily of any available delivery service providers.

13. The method of claim 2, wherein the delivery management system or a third party collects data from all completed deliveries.

14. The method of claim 13, wherein the delivery management system or the third party analyzes the collected data.

15. The method of claim 14, wherein the delivery management system or the third party shares the collected data with the delivery service provider.

16. A delivery management system comprising:
a database configured to store delivery information;
a computing device with a display configured to display the delivery information to a user and receive input from the user regarding delivery of a product;
a processor configured to provide delivery management application data based on a programmed command; and
a communication means for communicating data to a delivery service provider and for receiving delivery service provider commands.

17. The delivery management system of claim 17, wherein the delivery information includes delivery service provider information, available delivery location information, and delivery date and time information.

18. The delivery management system of claim 17, wherein the delivery service provider is a restaurant.

19. The delivery management system of claim 17, wherein the product is a restaurant prepared food product.
